(19) United States
(12) Patent Application Publication
(10) Pub. No.: US 2023/0332718 A1
(43) Pub. Date: Oct. 19, 2023

(54) A FLOATING PIPE COMPRISING A TUBE AND A FLOATER SURROUNDING SAID TUBE

(71) Applicant: DDC ENGINEERING B.V., Deventer (NL)

(72) Inventor: Dirk KNOL, Deventer (NL)

(73) Assignee: DDC ENGINEERING B.V., Deventer (NL)

(21) Appl. No.: 18/035,476

(22) PCT Filed: Nov. 11, 2021
(86) PCT No.: PCT/EP2021/081423

§ 371 Date: May 4, 2023

(30) Foreign Application Priority Data
Nov. 12, 2020 (NL) 2026886

(51) Int. Cl. F16L 1/24

(52) U.S. Cl. CPC F16L 1/24

(57) ABSTRACT

A floating pipe includes a tube and a floater surrounding the tube. The dimensions of the floating pipe are such that the floating pipe fits inside a 40-ft ISO container, and the circumference of the floater, seen in cross section in a central part of the floating pipe, is a square, a truncated circle, a rounded square, a squircle, or similar shape.

The invention relates to a floating pipe, for instance a floating dredge pipe, comprising a tube and a floater surrounding said tube. In particular the invention relates to floating pipes, the dimensions of which are designed to fit inside a 40-ft ISO container. Such containers have inner dimensions of 12,025 mm long, 2,352 mm wide and 2,393 mm high.

The ongoing increase in scale in the dredging industry necessitate applications of floating pressure pipes with internal diameters larger than 1,000 mm. These pipes provide the transport of sand-water mixtures from dredging equipment such as cutter suction dredgers and trailing suction hopper dredgers. Driven by higher production requirements, with the increase in cutting head power and installed pump powers, there is a need to increase the diameters of the floating pressure pipes, otherwise the flow speeds, losses and wear in the existing pipe systems will become too large.

To make these pipes float, floaters around the pipe generate an upward force through their displacement of water that keeps the pipe filled with dredge mixture afloat. Like the pipes, these floaters are tubular in shape, usually with sloping ends. The floaters are built on an inner pipe, made of steel or glass fiber reinforced epoxy, provided with a foam body and a fiber reinforced cover of rubber or polyurethane. These floaters are built using wrapping machines. The floater rotates while foam, reinforcement material and polymers are applied to the inner tube. After construction, the floater is vulcanized in an autoclave, provided that rubber elastomers have been used. Floaters may also be produced by rotational molding in a mold from polyethylene or may be produced by application of elastomers such at polyurethane compounds or similar elastomers which do not require vulcanization.

The floaters must be capable of being transported in standard 40-ft ISO shipping containers. Due to the increasing pipe diameters, it becomes necessary to use a larger floater volume. However, the diameter of these floaters then exceeds the internal dimensions of a standard shipping container, and it would be necessary to produce floaters that consist of several smaller parts which must be assembled together on site to build the float. This may be time consuming and expensive.

The invention addresses the above problem.

According to the invention the circumference of the floater, seen in cross section in a central part of the floating pipe, is a square, a truncated circle, a rounded square, a squircle, or similar shape. The terms “square” and “circle” in this respect should be understood to include equivalent rectangle and oval shapes which may deviate from perfect squares or circles, in order for the floater to fit in the respective shipping container. It will be apparent that the term “similar shape” cannot be understood so as to be a circle shape, as the aim of the invention is to obtain a larger floater volume than with a prior art floater having a circular cross section of the same height and width. The term similar shape should in fact be understood to include shapes that enclose a circle (or oval) of the same height and width, and having a surface area that is larger than the surface area of said circle (or oval).

Preferably the largest diameter, which is a diagonal of the floater, seen in cross section in a central part of the floating pipe, is between 2,353 mm (i e larger than the width of a 40-ft ISO container) and 3,354 mm (i.e. smaller than the maximum inner diameter of a 40-ft ISO container), preferably between 2,500 mm and 3,354 mm, more preferably approximately 2,570 mm. Preferably the smallest diameter, which is a width and/or height of the floater, seen in cross section in a central part of the floating pipe, is smaller than 2,352 mm (i e smaller than the width of a 40-ft ISO container), preferably between 2,150 mm and 2,350 mm, more preferably approximately 2,250 mm.

Preferably the circumference of the tube, seen in cross section in a central part of the floating pipe, is a circle. Preferably the inner diameter of the tube is between 800 mm and 1,500 mm, preferably between 1,000 mm and 1,200 mm, preferably approximately 1,100 mm. Preferably, in order to fit in a 40-ft ISO container, the length of the pipe is between 10,000 mm and 12,025 mm, preferably between 11,000 mm and 12,000 mm, more preferably approximately 11,800 mm. Preferably, in order to fit in a 40-ft ISO container, the length of the floater is between 8000 mm and 12,000 mm, preferably between 9,000 and 11,000, more preferably 10,500 mm. If shipping containers of other lengths (such as an 20-ft ISO container) or other sizes are used for shipping, the above mentioned sizes should be adapted accordingly.

Preferably the tube is provided with flanges at both outer ends which flanges are arranged to releasably connect two adjacent tubes to each other. Preferably the tube is made of a metal, such as steel, preferably Q345B steel, or of a glass fibre reinforce epoxy.

Preferably the floater 3 comprises an interior body made of a closed cell foam, such as foam 90. Preferably the floater comprises a outer cover made of rubber, such as NR or SBR, which is preferably between 10 and 40 mm, preferably between 15 and 25 mm, more preferably approximately 20 mm thick. Preferably the floater comprises an inner pipe arranged around the tube, which inner pipe is connected at its outer ends to the outer cover, and the interior body is disposed between the inner pipe and the outer cover. Preferably the inner pipe is made of a metal, such as steel, preferably 5235 steel.

The invention also relates to a floater for use in a floating pipe in accordance with any of the previous claims, characterized in that the circumference of the floater 3, seen in cross section in a central part of the floater, is a square, a truncated circle, a rounded square, a squircle, or similar shape.

The invention will be illustrated by means of a preferred embodiment, with reference to the figures, wherein:

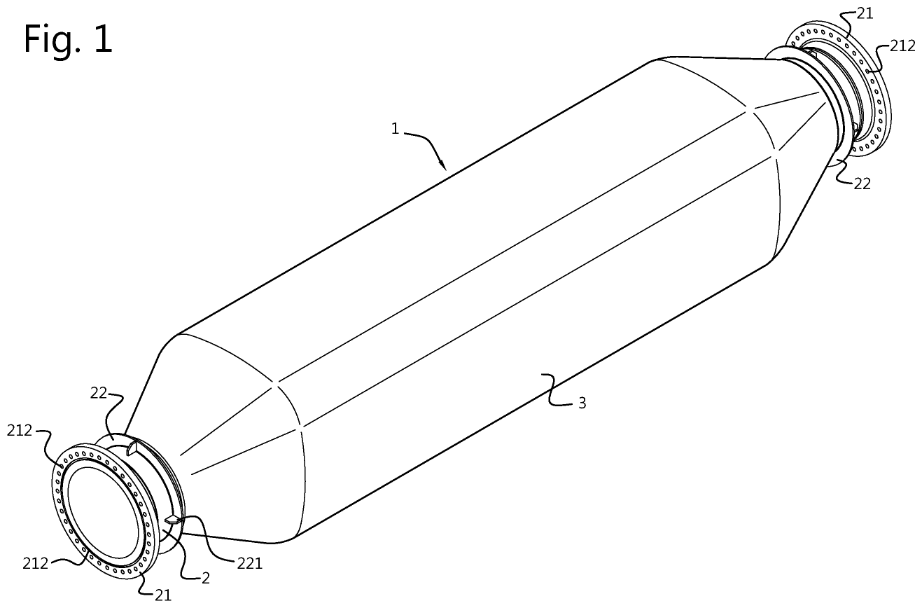

FIG. 1 is a perspective view of a floating dredging hose in accordance with the invention;

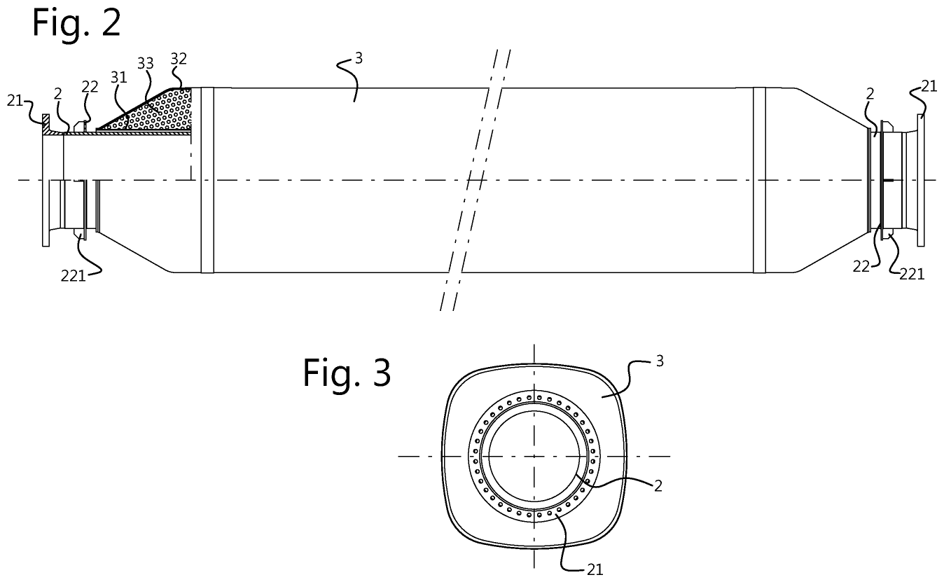

FIG. 2 is a partial longitudinal section of the dredging hose of FIG. 1;

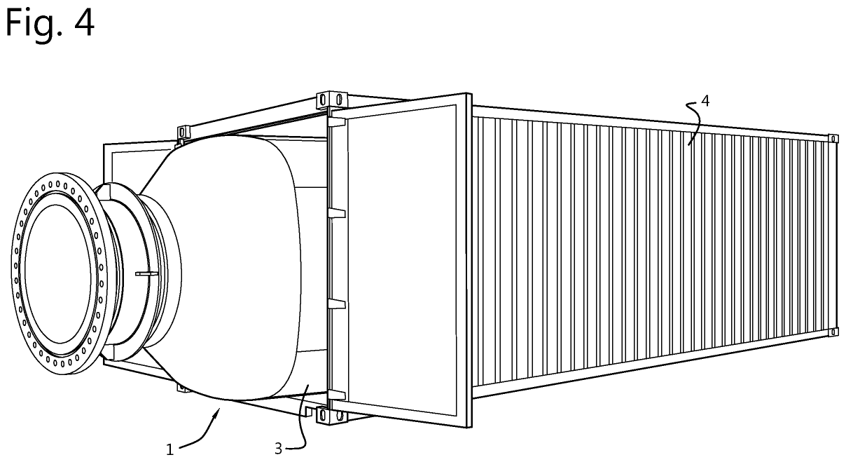

FIG. 3 is a cross section of the dredging hose of FIGS. 1; and

FIG. 4 is a perspective of the floating dredging hose of FIG. 1 which is partially inserted in a 40-ft ISO shipping container.

According to figures a floating dredge pipe 1 comprises a steel tube 2 having flanges 21 at both ends. Each flange is provided with holes 211 for connecting two flanges 21 of two adjacent dredge pipes 1, and at least one of said flanges 21 is provided with a groove 212 for accommodating a rubber seal. Steel rings 22 are mounted on the tube 2 by means of gussets 221 near both ends of the tube 22, in order to contain the floater 3, which surrounds the tube 2 but is separate therefrom, between them.

The floater 3 comprises an inner steel pipe 31 and a rubber cover 32 connected thereto at both ends so as to enclose a floater volume which is filled with a closed cell foam which forms an interior body 33 of the floater 3.

In this exemplary embodiment, the steel tube 2 has a length of 11,800 mm and an inner diameter of 1,100 mm. The length of the floater 3 is 10.500 mm and the floater has conical, sloping ends. As seen in the cross section of FIG. 3, the circumference of the floater 3 is approximately a rounded square or squircle, and the diagonal between the rounder corners of the floater is 2,570 mm, whereas the width and height of the floater is 2,250 mm. In that manner the floater narrowly fits inside the container 4, thereby maximizing the floating capacity of the dredge pipe 1.

The invention has thus been described by means of a preferred embodiment. It is to be understood, however, that this disclosure is merely illustrative. Various details of the structure and function were presented, but changes made therein, to the full extent extended by the general meaning of the terms in which the appended claims are expressed, are understood to be within the principle of the present invention. The description and drawings shall be used to interpret the claims. The claims should not be interpreted as meaning that the extent of the protection sought is to be understood as that defined by the strict, literal meaning of the wording used in the claims, the description and drawings being employed only for the purpose of resolving an ambiguity found in the claims. For the purpose of determining the extent of protection sought by the claims, due account shall be taken of any element which is equivalent to an element specified therein. An element is to be considered equivalent to an element specified in the claims at least if said element performs substantially the same function in substantially the same way to yield substantially the same result as the element specified in the claims.

1. A floating pipe comprising a tube and a floater surrounding said tube, wherein the circumference of the floater, seen in cross section in a central part of the floating pipe, is a square, a truncated circle, a rounded square, or a squircle.

2. The floating pipe in accordance with claim 1, wherein the dimensions of the floating pipe are designed to fit inside a 40-ft ISO container, having inner dimensions of 12,025 mm long, 2,352 mm wide and 2,393 mm high.

3. The floating pipe in accordance with claim 1, wherein the largest diameter, which is a diagonal of the floater, seen in cross section in a central part of the floating pipe, is between 2,353 mm and 3,354 mm.

4. The floating pipe in accordance with claim 1, wherein the smallest diameter, which is a width and/or height of the floater, seen in cross section in a central part of the floating pipe, is smaller than 2,352 mm.

5. The floating pipe in accordance with claim 1, wherein the circumference of the tube, seen in cross section in a central part of the floating pipe, is a circle.

6. The floating pipe in accordance with claim 1, wherein the inner diameter of the tube is between 800 mm and 1,500 mm.

7. The floating pipe in accordance with claim 1, wherein the length of the tube pipe is between 10,000 mm and 12,025 mm.

8. The floating pipe in accordance with claim 1, wherein the length of the floater is between 8000 mm and 12,000 mm.

9. The floating pipe in accordance with claim 1, wherein the tube is provided with flanges at both outer ends which flanges are arranged to releasably connect two adjacent tubes to each other.

10. The floating pipe in accordance with claim 1, wherein the tube is made of a metal.

11. The floating pipe in accordance with claim 1, wherein the floater comprises an interior body made of a closed cell foam.

12. The floating pipe in accordance with claim 1, wherein the floater comprises an outer cover made of rubber, which is between 10 and 40 mm.

13. The floating pipe in accordance with claim 1, wherein the floater comprises an inner pipe arranged around the tube, which inner pipe is connected at its outer ends to the outer cover, and the interior body is disposed between the inner pipe and the outer cover.

14. The floating pipe in accordance with claim 1, wherein the inner pipe is made of a metal, such as steel.

15. A floater for use in the floating pipe in accordance with claim 1, wherein the circumference of the floater, seen in cross section in a central part of the floater, is a square, a truncated circle, a rounded square, or a squircle.
